(19) United States
(12) Patent Application Publication
(10) Pub. No.: US 2009/0309921 A1
(43) Pub. Date: Dec. 17, 2009

(54) RECORDING APPARATUS

(75) Inventors: Kazuo Ohyama, Kawasaki-shi (JP); Yasuhiko Ikeda, Sagamihara-shi (JP); Akira Kida, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/483,595

(22) Filed: Jun. 12, 2009

(30) Foreign Application Priority Data
Jun. 16, 2008 (JP) 2008-156634

(51) Int. Cl. B41J 23/00

(52) U.S. Cl. 347/37

(57) ABSTRACT

A recording apparatus includes a carriage on which a recording head is mounted, the recording head ejecting liquid onto a recording medium, and a guiding member that guides the movement of the carriage, a sliding member that moves together with the carriage and slides on the guide member, and a distance control member for controlling the distance between the recording head and the recording medium. The distance control member is nipped between the carriage and the sliding member in the direction substantially perpendicular to the recording surface of the recording medium. The carriage, the sliding member, and the distance control member can be put in a combined state where they are combined with each other. The recording apparatus further includes a preventing portion for preventing the carriage, the sliding member, and the distance control member in the combined state from moving in the direction substantially perpendicular to the recording surface.

### BACKGROUND OF THE INVENTION

1. Field of the Invention

The present invention relates to a recording apparatus that ejects liquid from a recording head and records an image on a recording medium.

2. Description of the Related Art

Recording apparatuses such as printers, copiers, and facsimile machines have a recording head that ejects liquid ink onto a sheet-like recording medium such as paper or a plastic sheet. The recording head is mounted on a carriage. The carriage is configured to be movable in the recording medium conveying direction (hereinafter also referred to as sub-scanning direction) and the direction perpendicular thereto (hereinafter also referred to as main scanning direction).

The carriage is moved in the main scanning direction, and ink is ejected from the recording head to a recording medium. By moving the recording medium in the sub-scanning direction, recording is performed on the recording medium.

Some recording apparatuses perform recording on thick recording media such as an envelope, heavy paper, or a CD-R. Since these recording media have different thicknesses, the distance between the recording head and a recording medium (hereinafter referred to as paper distance) varies depending on the type of the recording medium. To improve the quality of a recorded image, the paper distance needs to be maintained within an appropriate range.

Therefore, in a recording apparatus that performs recording on recording media having different thicknesses, the paper distance needs to be controlled according to the thickness of the recording medium. When recording is performed on a recording medium such as glossy paper, the paper distance needs to be reduced to form a high quality image.

A recording apparatus described in Japanese Patent Laid-Open No. 2004-42346 meets such needs. The recording apparatus described in Japanese Patent Laid-Open No. 2004-42346 has a carriage on which a recording head is mounted and that moves in the direction perpendicular to the recording medium conveying direction, and a guide shaft that guides the movement of the carriage.

The recording apparatus further has a guide shaft lifting and lowering unit. The guide shaft lifting and lowering unit varies the height of the guide shaft in three or more steps without moving the guide shaft in the recording medium conveying direction.

In the recording apparatus described in Japanese Patent Laid-Open No. 2004-42346, the guide shaft is lifted and lowered by rotating cams provided at both ends of the guide shaft. A chassis is provided with a surface with which the cams are in contact. The distance between the chassis and the guide shaft is changed with the rotation of the cams.

However, the recording apparatus described in Japanese Patent Laid-Open No. 2004-42346 has following problems. The recording apparatus described in Japanese Patent Laid-Open No. 2004-42346 has cams provided at both ends of a guide shaft, a spring that urges the guide shaft downward, and a driving source for rotating the cams.

The driving source needs to generate sufficient torque to lift the carriage, and a motor, a reduction gear train, and so forth need to be used. Therefore, the configuration of the recording apparatus is complicated, and the production cost of the recording apparatus increases. Therefore, it is desired to stably control the paper distance using a paper distance control mechanism having a simple configuration.

### SUMMARY OF THE INVENTION

The present invention stably controls the gap between a recording head and a recording medium (paper distance).

In an aspect of the present invention, a recording apparatus includes a carriage on which a recording head is mounted, the recording head ejecting liquid onto a recording medium, and a guiding member that guides the movement of the carriage, a sliding member that moves together with the carriage and that slides on the guide member, and a distance control member for controlling the distance between the recording head and the recording medium, the distance control member being nipped between the carriage and the sliding member in the direction substantially perpendicular to the recording surface of the recording medium. The carriage, the sliding member, and the distance control member are configured to be able to be put in a combined state where they are combined with each other.

Further features of the present invention will become apparent from the following description of exemplary embodiments with reference to the attached drawings.

### BRIEF DESCRIPTION OF THE DRAWINGS

FIG. 1 is a schematic perspective view of a recording apparatus according to an embodiment of the present invention.

FIG. 2 is a schematic side view of a recording apparatus according to an embodiment of the present invention.

FIG. 3 is a schematic side view of a carriage unit according to an embodiment of the present invention.

FIG. 4 is a schematic rear view of a carriage unit according to an embodiment of the present invention.

FIG. 5 is an enlarged schematic perspective view of the sliding member and the distance control member of the carriage and the neighborhood thereof.

FIG. 6 is an exploded view of the carriage, the distance control member, and the sliding member.

FIG. 7 is an exploded view of the carriage, the distance control member, and the sliding member.

FIG. 8 is a schematic rear view of the carriage unit in a combined state and in a state where the cap unit is in close contact with the ejection ports of the recording head.

FIG. 9 is a schematic perspective view of the recording apparatus for showing preventing portions provided in the guiding member.

FIG. 10 is an enlarged schematic perspective view showing only the guiding member and the sliding member.

FIG. 11 is a schematic rear view of the carriage unit for showing the distance control member located at a first control position.

FIG. 12 is a schematic rear view of the carriage unit for showing the distance control member located at a second control position.

FIG. 13 is a schematic rear view of the carriage unit for showing the distance control member located at a third control position.

FIG. 14 is a schematic rear view of the carriage unit for showing the distance control member located at a fourth control position.

FIG. 15 is a schematic perspective view of the recording apparatus that is conveying a CD-R conveying tray.

### DESCRIPTION OF THE EMBODIMENTS

The embodiments of the present invention will now be described with reference to the drawings.

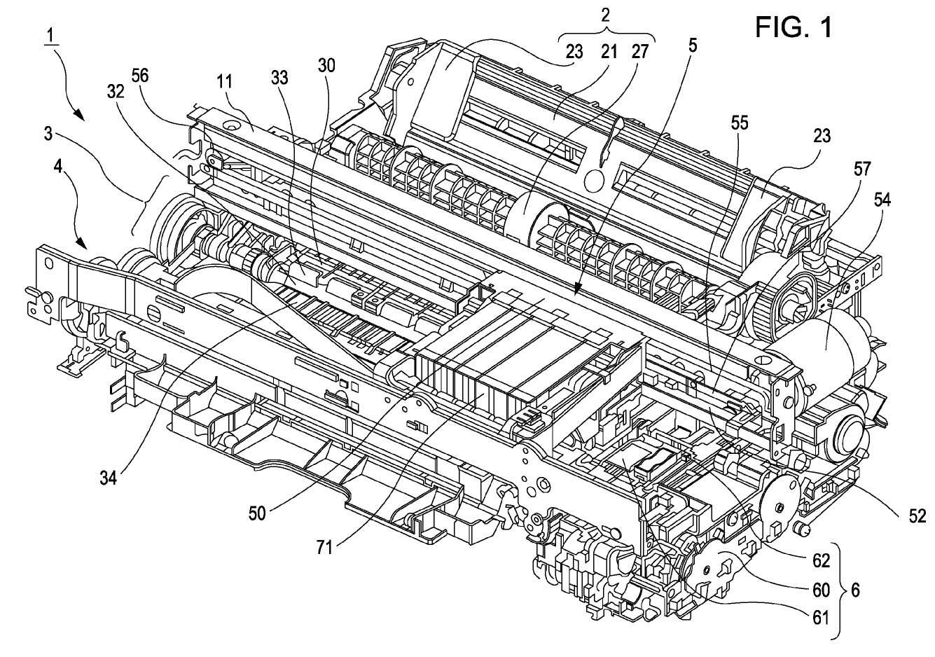

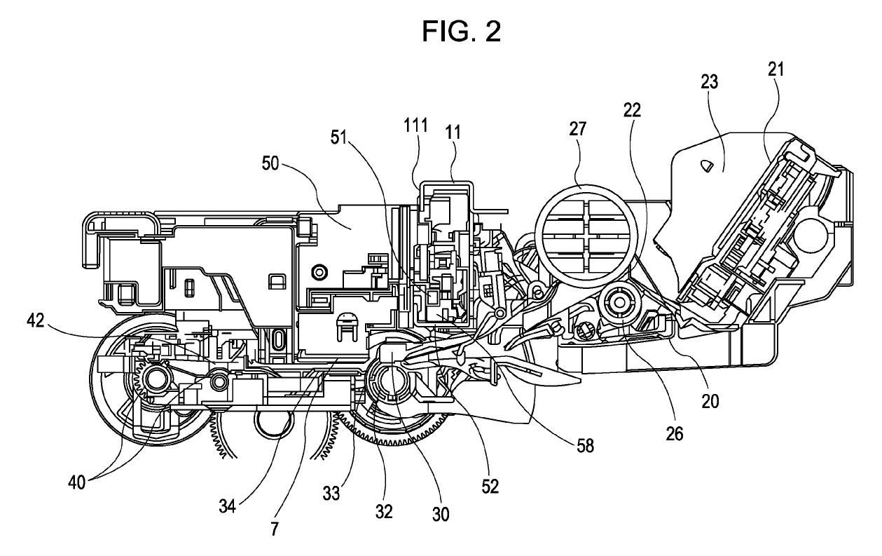

FIG. 1 is a schematic perspective view of a recording apparatus according to an embodiment of the present invention. FIG. 2 is a schematic side view of the recording apparatus of FIG. 1. A recording apparatus 1 has a feeding mechanism 2, a conveying section 3, an ejecting section 4, a carriage unit 5, and a recovery mechanism 6.

The carriage unit 5 has a recording head 7 that ejects liquid ink, and a carriage 50 on which the recording head 7 is mounted. The recording head 7 ejects liquid (for example, ink), thereby performing recording on a recording medium.

The feeding mechanism 2 is loaded with a recording medium. The recording medium is conveyed through the conveying section 3 to a position where the recording medium faces the recording head 7. After undergoing recording, the recording medium is ejected through the ejecting section 4 out of the recording apparatus 1. The recovery mechanism 6 is provided to recover the ejecting function of the recording head 7.

The recording apparatus 1 is provided with a platen 34 that faces a surface of the recording head 7 from which liquid is ejected (hereinafter also referred to as ejection surface). The platen 34 is provided to support a recording medium undergoing a recording operation.

The ejection surface of the recording head 7 faces a recording medium supported by the platen 34 while keeping an appropriate distance from the recording medium. Hereinafter, the distance between the recording head 7 and a recording medium will be referred to as paper distance.

Main components of the recording apparatus 1 will be described.

### (A) Carriage Unit

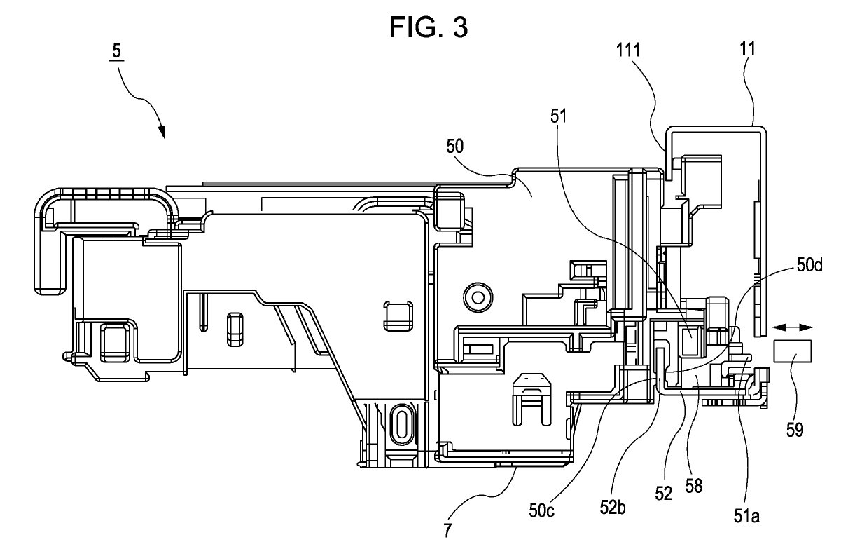

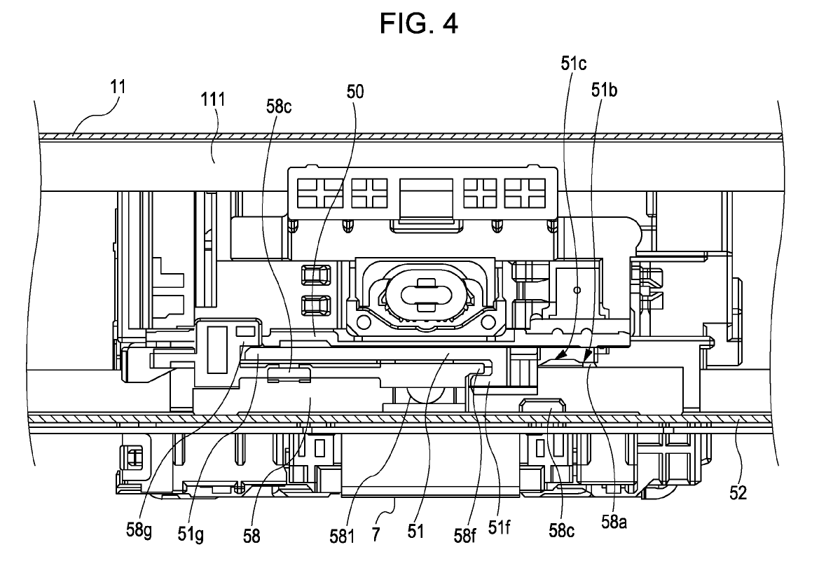

FIG. 3 is a schematic side view of the carriage unit 5 in this embodiment. FIG. 4 is a schematic rear view of the carriage unit 5. The carriage 50 is supported by a guiding member 52 and a supporting member 111 extending along the main scanning direction, and is configured to be movable along the main scanning direction.

The supporting member 111 is nipped by the carriage 50 from both sides in the recording medium conveying direction. The supporting member 111 is formed integrally with a chassis 11 of the recording apparatus 1 and supports the upper part of the carriage 50. The upper part of the carriage 50 is pressed against the supporting member 111 by its own weight, and the posture of the carriage 50 is maintained.

The guiding member 52 is attached to the chassis 11. The guiding member 52 extends along the main scanning direction and guides the movement of the carriage 50. The edge 52b of the guiding member 52 on the sub-scanning direction side is bent into an L shape. The edge 52b is nipped between a first sliding surface 50c and a second sliding surface 50d formed in the carriage 50. The guiding member 52 can be made of sheet metal. By making the guiding member 52 of sheet metal, the production cost is made lower than that in the case where the guiding member 52 is a metal shaft.

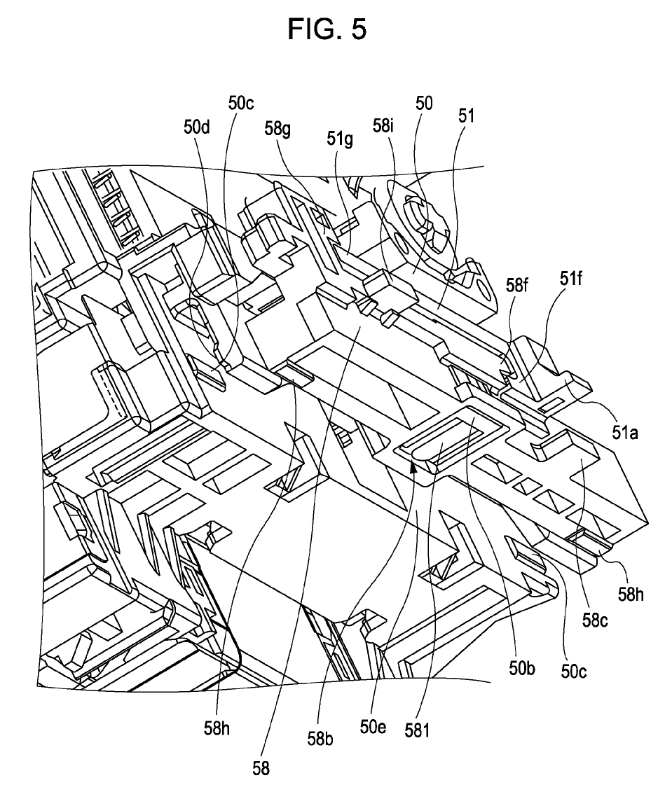

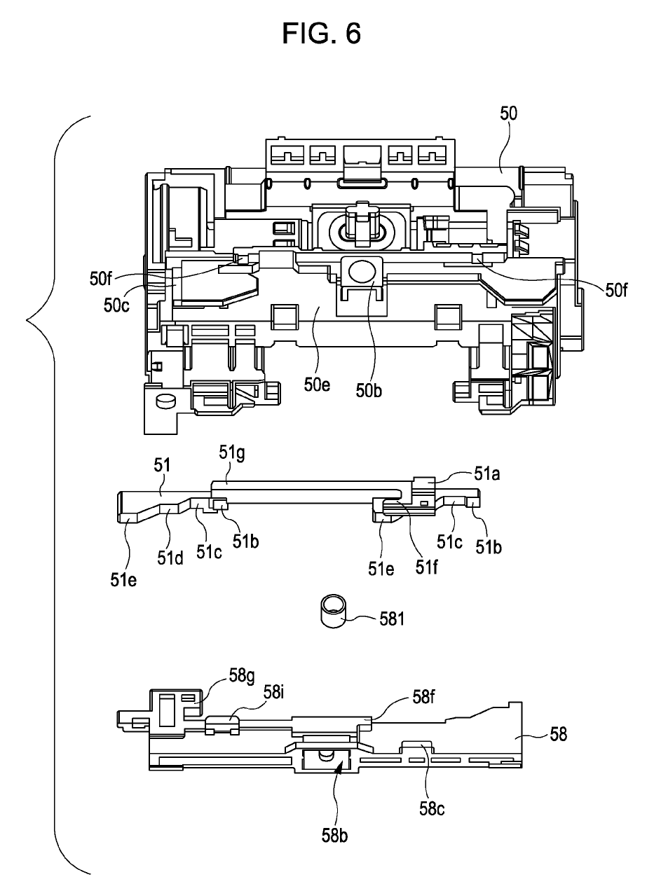

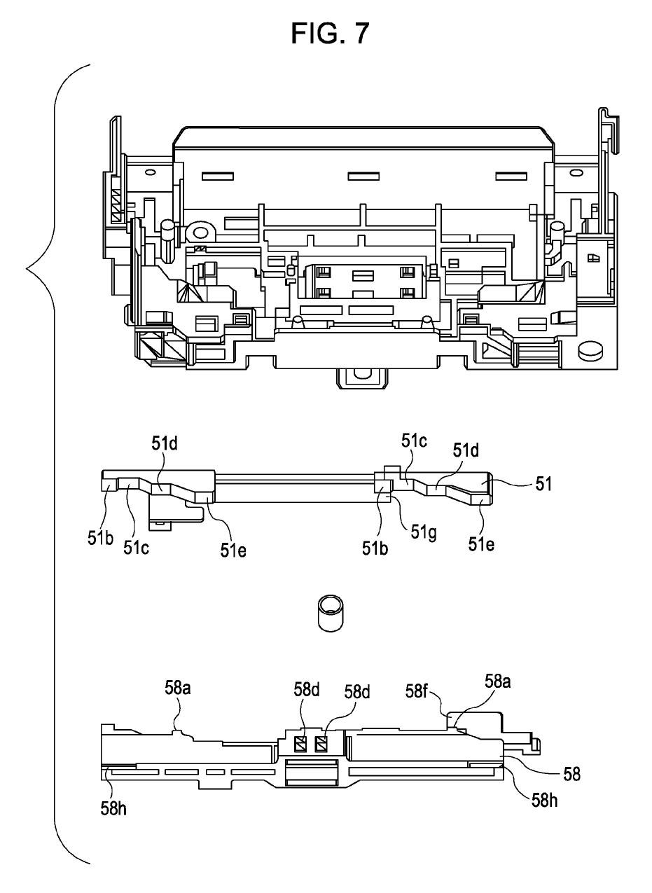

The carriage 50 has a sliding member 58 and a distance control member 51. FIG. 5 is an enlarged schematic perspective view of the sliding member 58 and the distance control member 51 of the carriage 50 and the neighborhood thereof. However, the guiding member 52 is not shown in FIG. 52. FIG. 6 is an exploded view of the carriage 50 with the sliding member 58 and the distance control member 51 removed, as viewed from obliquely below on the chassis 11 side. FIG. 7 is the same exploded view as FIG. 6, as viewed from obliquely below on an ejecting roller 40 side.

The sliding member 58 has an opening 58b that opens in the direction substantially perpendicular to the plane defined by the main scanning direction and the sub-scanning direction. The plane defined by the main scanning direction and the sub-scanning direction is parallel to the surface of a recording medium on which recording is performed (hereinafter referred to as recording surface).

By inserting an inserting portion 50b formed in the carriage 50 into the opening 58b formed in the sliding member 58, the sliding member 58 is prevented from moving relative to the carriage 50 in the main scanning direction. Therefore, the sliding member 58 moves in the main scanning direction together with the carriage 50.

Between the inner surface of the opening 58b on the sub-scanning direction side and the inserting portion 50b of the carriage 50 is provided a compression spring 581, which urges the sliding member 58 toward the downstream side in the recording medium conveying direction.

The end faces 58d of the sliding member 58 on the downstream side in the conveying direction face one surface 50e of the carriage 50. Between the surface 50e and the end faces 58d facing each other, the edge 52b of the guiding member 52 bent into an L shape is nipped. Thus, the posture of the carriage 50 in the sub-scanning direction is stabilized.

In the direction substantially perpendicular to the recording surface, sliding surfaces 58h of the sliding member 58 are in contact with the guiding member 52, and the sliding member 58 is slidably supported by the guiding member 52.

In the direction substantially perpendicular to the recording surface, the distance control member 51 is nipped between the carriage 50 and the sliding member 58. Thus, the distance control member 51 controls the distance between the carriage 50 and the sliding member 58.

Due to the above configuration, the carriage 50 is supported by the guiding member 52 with the sliding member 58 and the distance control member 51 therebetween. Thus, the position of the carriage 50 in the direction substantially perpendicular to the recording surface is defined. By adjusting the position of the guiding member 52 at the time of manufacture, the position of the carriage 50 is appropriately adjusted.

The distance control member 51 extends along the main scanning direction. The thickness of the distance control member 51 in the direction substantially perpendicular to the recording surface varies depending on the position on the distance control member in the main scanning direction. In this embodiment, the thickness of the distance control member 51 varies in four steps. The distance control member 51 is configured to be slidable relative to the carriage 50 in the direction in which the carriage 50 moves. On the sliding member 58 side of the distance control member 51, a cam surface is formed.

As the distance control member 51 slides, the thickness of the distance control member 51 at the contact point between the carriage 50 and the sliding member 58 varies, and the distance between the carriage 50 and the sliding member 58 varies. Therefore, the distance between the recording head 7 mounted on the carriage 50 and the platen 34 fixed to the chassis 11 can be varied.

That is, the paper distance can be controlled by sliding the distance control member 51 according to the thickness or type of the recording medium supported by the platen 34. As described above, the distance control member 51 is provided to control the paper distance.

Next, a specific example of a configuration for sliding the distance control member 51 will be described in detail. As shown in FIG. 3, the recording apparatus 1 according to this embodiment has a switching member 59 for sliding the distance control member 51.

The switching member 59 is attached to the chassis 11 and is disposed on the upstream side of the distance control member 51 in the conveying direction. The switching member 59, driven by a driving source (not shown), can move in the sub-scanning direction, can enter an area where the distance control member 51 slides, and can be retracted out of the area.

The distance control member 51 has a protrusion 51a that protrudes in the direction in which the switching member 59 is disposed. The switching member 59 can be moved by the driving source between a position where the switching member 59 comes into contact with the protrusion 51a of the distance control member 51 when the carriage 50 moves in the main scanning direction, and a position where the switching member 59 does not come into contact with the protrusion 51a of the distance control member 51 when the carriage 50 moves in the main scanning direction.

When the carriage 50 is moved in the main scanning direction, with the switching member 59 in the sliding area of the distance control member 51, the switching member 59 collides with the protrusion 51a so as to prevent the movement of the distance control member 51 moving together with the carriage 50. By further moving the carriage 50, the distance control member 51 is slid relative to the carriage 50.

As described above, the recording apparatus 1 of this embodiment can control the paper direction with a simple configuration. In addition, a driving source that generates sufficient torque for lifting the carriage and a reduction gear train such as those described in Japanese Patent Laid-Open No. 2004-42346 need not be provided, and therefore the recording apparatus 1 has a simple configuration. Accordingly, the production cost of the recording apparatus 1 is reduced.

To recover the ejecting function of the recording head 7 mounted on the carriage 50, the recording apparatus 1 is provided with the recovery mechanism 6. The recovery mechanism 6 has a cap unit 61 to be described below. The recording head 7 is moved to a position where the recording head 7 faces the cap unit 61, and the cap unit 61 is raised and brought into close contact with the ejection surface of the recording head 7. This state will be referred to as capping state. That is, the cap unit 61 applies a force in the direction substantially perpendicular to the recording surface, to the recording head 7 and the carriage 50.

The carriage 50 can move to control the paper distance, in the direction substantially perpendicular to the recording surface. If the cap unit 61 is raised with the carriage 50 movable upward, the carriage 50 is pushed upward, and therefore the cap unit 61 cannot be pressed against the recording head 7 at sufficient pressing force. Therefore, the closeness of contact between the recording head 7 and the cap unit 61 decreases. This may decrease the effect of recovery of the recording head 7.

Therefore, to increase the closeness of contact in the capping state, the cap unit 61 needs to follow the carriage 50 up to the end of the movable area of the carriage 50 in the direction perpendicular to the recording surface. However, in this case, the configuration of the cap unit 61 may increase in size, and the height of the apparatus may increase.

As described above, the carriage 50 is configured to be able to vary the distance to the sliding member 58. That is, the spring 581 fitted in the opening 58b of the sliding member 58 does not have sufficient force to prevent the carriage 50 from moving relative to the sliding member 58 in the direction substantially perpendicular to the recording surface.

Therefore, when the carriage 50 is moved by the capping operation of the cap unit 61 in the direction substantially perpendicular to the recording surface, the sliding member 58 and the distance control member 51 do not always follow the carriage 50. Therefore, the distance between the carriage 50 and the sliding member 58 may increase, the distance control member 51 may be destabilized, the distance control member 51 may shift, and the paper distance may slightly vary.

Since the carriage unit 5 may be destabilized as described above, the recording apparatus 1 according to this embodiment further has the following configuration.

The recording apparatus 1 has a combined state where the carriage 50, the sliding member 58, and the distance control member 51 are combined with each other in the direction substantially perpendicular to the recording surface. In this combined state, the carriage 50, the sliding member 58, and the distance control member 51 are united.

Therefore, even when a capping operation is performed, the carriage 50, the sliding member 58, and the distance control member 51 are united and stable. Thus, the stability of the carriage unit 5 is improved.

Furthermore, the recording apparatus 1 has a preventing portion 52a for preventing the carriage 50, the sliding member 58, and the distance control member 51 in a combined state from moving in the direction substantially perpendicular to the recording surface.

The preventing portion 52a desirably prevents the carriage 50 from moving upward when the carriage 50 is located at a position where the recording head 7 and the cap unit 61 face each other. In such a configuration, when the cap unit 61 is pressed against the recording head 7 mounted on the carriage 50, the closeness of contact between the recording head 7 and the cap unit 61 is improved.

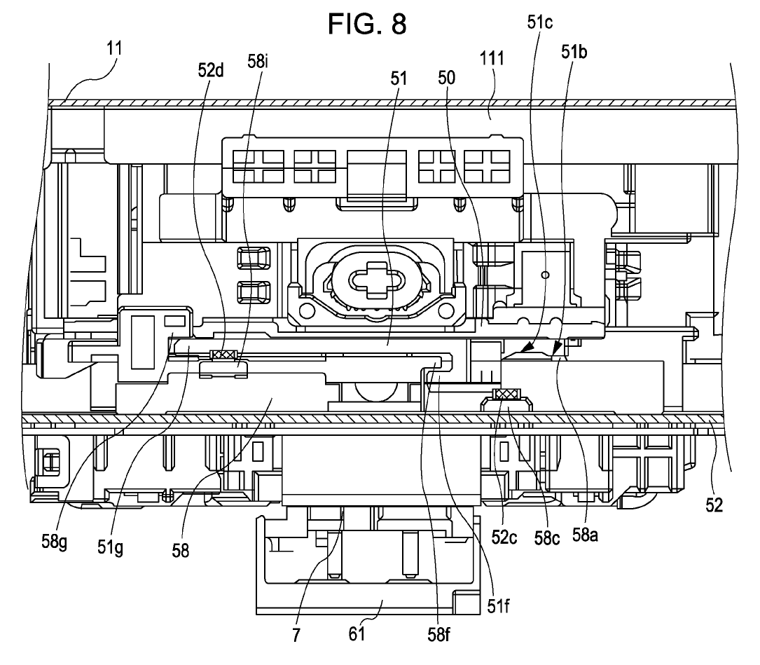

FIG. 8 is a schematic rear view of the carriage unit 5 in a combined state and shows a state where the cap unit 61 is in close contact with the recording head 7. In FIG. 8, the distance control member 51 is located at the end of its slidable area.

In a part of the distance control member 51, a hook-like first engaging portion 51f is provided. When the distance control member 51 is slid leftward in FIG. 8, the first engaging portion 51f catches a second engaging portion 58f that constitutes a part of the sliding member 58 and prevents the sliding member 58 from moving relative to the distance control member 51 in the direction substantially perpendicular to the recording surface. This state is a combined state.

Furthermore, in the combined state, a third engaging portion 51g that is an edge of the distance control member 51 is fitted in a hook-like fourth engaging portion 58g formed in the sliding member 58. Due to such a structure, the distance control member 51 and the sliding member 58 are combined with each other in the direction substantially perpendicular to the recording surface.

The distance control member 51, nipped between third sliding surfaces 50f formed in the carriage 50, is prevented from moving relative to the carriage 50 in the direction perpendicular to the recording surface. Thus, the distance control member 51 and the carriage 50 are combined with each other.

In this way, the carriage 50, the sliding member 58, and the distance control member 51 are put in a combined state where they are combined with each other. As described above, the inserting portion 50b and the engaging portions 50a, 51f, 51g, 58f, and 58g constitute a relative movement preventing unit that prevents the carriage 50 from moving relative to the sliding member 58.

In the combined state, when the distance control member 51 slides relative to the carriage 50 and the sliding member 58 rightward in FIG. 8, the combined state between the distance control member 51 and the sliding member 58 is released. The distance control member 51 can be brought into the combined state by sliding, and therefore the configuration of the recording apparatus 1 is simple.

As described above, in this embodiment, by sliding the distance control member 51 relative to the carriage 50 and the sliding member 58, the carriage 50, the sliding member 58, and the distance control member 51 can be brought into and out of a combined state. Thus, combination and release thereof are performed with a simple mechanism.

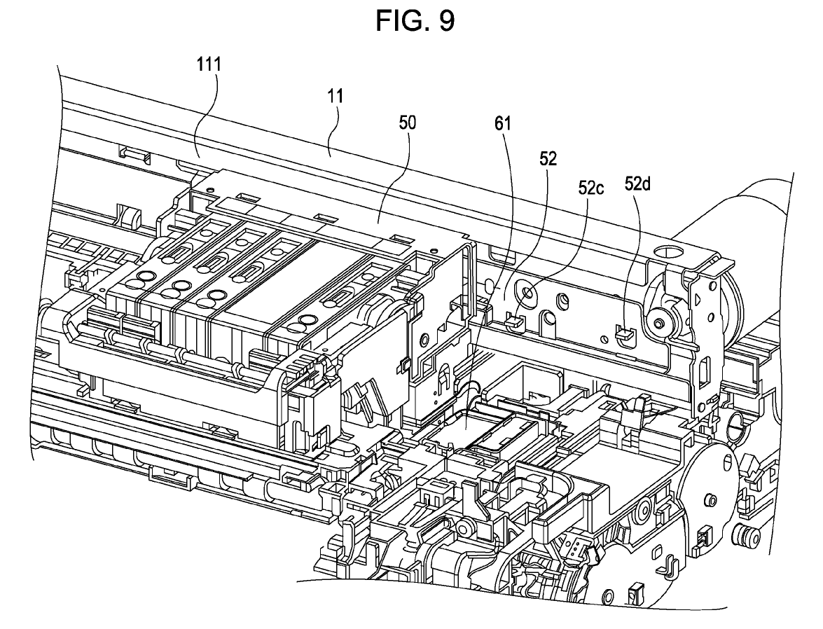

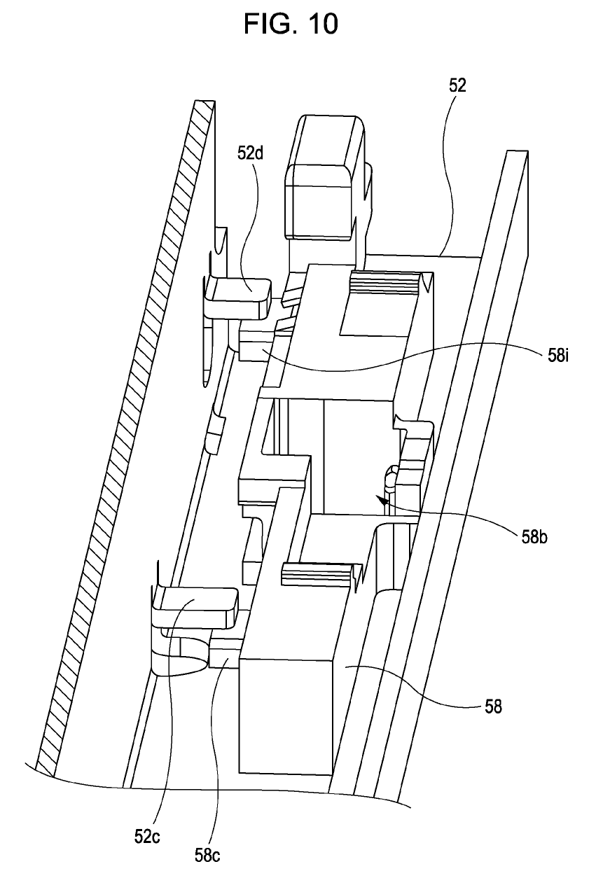

Next, the configuration of a first preventing portion 52c and a second preventing portion 52d will be specifically described. In this embodiment, the first preventing portion 52c and the second preventing portion 52d are integrally provided in the guiding member 52. FIG. 9 is a schematic perspective view of the recording apparatus 1 for showing the first preventing portion 52c and the second preventing portion 52d provided in the guiding member 52. FIG. 10 is an enlarged schematic perspective view showing only the guiding member 52 and the sliding member 58.

The first preventing portion 52c and the second preventing portion 52d are formed in the guiding member 52 integrally therewith. The first preventing portion 52c and the second preventing portion 52d protrude toward the sliding member 58. The sliding member 58 has a first prevented portion 58c and a second prevented portion 58i that protrude toward the guiding member 52.

As shown in FIG. 8, when the recording head 7 is opposite the cap unit 61, the undersurface of the first preventing portion 52c is in contact with the upper surface of the first prevented portion 58c. Similarly, the undersurface of the second preventing portion 52d is in contact with the upper surface of the second preventing portion 58i. In this way, the first and second preventing portions 52c and 52d prevent the movement of the sliding member 58. At this time, by bringing the carriage unit 5 into a combined state, the carriage 50 is prevented from moving upward relative to the recording apparatus 1.

According to the above configuration, also when a force in the direction substantially perpendicular to the recording surface is applied to the carriage 50, the carriage 50 can be prevented from being significantly lifted. In addition, the configurations of the engaging portions 50a, 51f, 51g, 58f, and 58g and the first and second preventing portions 52c and 52d are simple, and therefore the configuration of the recording apparatus 1 is simple. Moreover, since a prevented state can be formed just by moving the carriage 50, the configuration of the recording apparatus is simple.

Since the carriage 50 is prevented from moving in the direction substantially perpendicular to the recording surface, the recovery mechanism 6 need not be increased in size, and a space-efficient recording apparatus can be provided.

For the engaging portions 50a, 51f, 51g, 58f, and 58g engaged with each other, appropriate dimension tolerances or gaps therebetween may be permitted. In this case, after moving by the dimension tolerances or gaps, the carriage is prevented from moving.

It is only necessary to form at least one of the first and second preventing portions 52c and 52d in the guiding member 52. Although the first and second preventing portions 52c and 52d prevent the movement of the sliding member 58 in this embodiment, the recording apparatus may be configured so that the preventing portions prevent the movement of the carriage 50 or the distance control member 51.

The configurations of the engaging portions 50a, 51f, 51g, 58f, and 58g are not limited to those described above. They may have any configuration as long as the carriage 50, the sliding member 58, and the distance control member 51 can be engaged with each other.

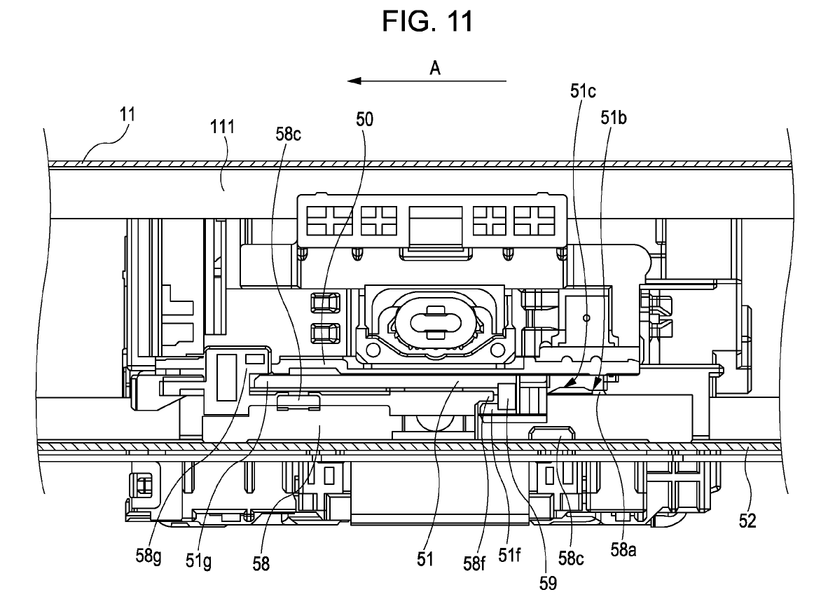

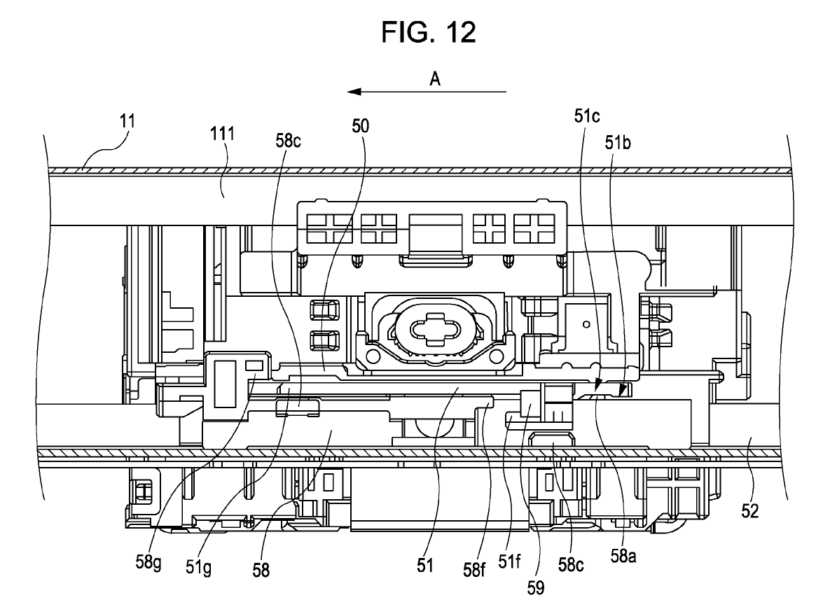

Next, an operation for controlling the paper distance in the recording apparatus 1 having the above-described configuration will be described with reference to FIGS. 11 and 12. In this embodiment, the distance control member 51 is slid according to the thickness and type of the recording medium so as to control the paper distance. Examples of a recording medium include typical recording paper, glossy paper, heavy paper, and a CD-R.

In this embodiment, according to the thickness or type of the recording medium, the position of the distance control member 51 relative to the carriage 50 can be controlled at the following four control positions.

A first control position: a position for performing printing on a recording medium about 0.1 mm thick, for example, plain paper. A second control position: a position for performing recording on glossy paper with which a high-quality image can be obtained. A third control position: a position for performing printing on an envelope, heavy paper, or a recording medium that is very prone to curl. A fourth control position: a position for performing printing on a label surface of a CD or a CD-R held in a conveying tray. The distance between the carriage 50 and the sliding member 58 increases in the order of the second control position, the first control position, the third control position, and the fourth control position.

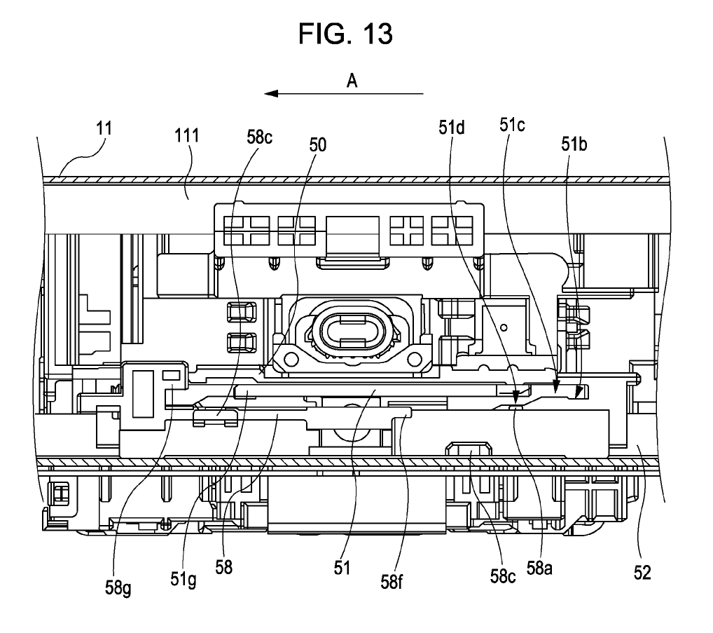

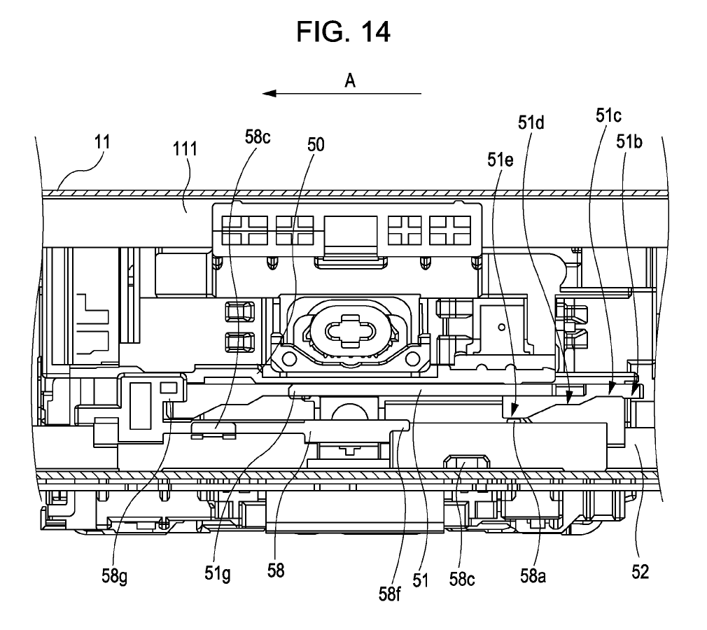

FIGS. 11, 12, 13, and 14 are schematic rear views of the carriage unit 5 for showing the distance control member 51 at the first, second, third, and fourth control positions, respectively. To make FIGS. 13 and 14 easy to understand, the protrusion 51a of the distance control member 51 and the switching member 59 are not shown therein. FIGS. 4 to 6 show the carriage unit 5 at the first control position.

At the first control position, a first contact surface 51b of the distance control member 51 is in contact with a supporting surface 58a provided in the sliding member 58. At the first control position, the carriage 50, the sliding member 58, and the distance control member 51 are put in an combined state where they are combined with each (see FIG. 11).

Next, a description will be given of an operation to switch from the first control position to the second control position. First, the switching member 59 is made to enter the movable area of the protrusion 51a of the distance control member 51. At this time, the switching member 59 is brought into contact with one side surface of the protrusion 51a in the main scanning direction (the side surface on the side of the direction of the arrow A in FIG. 11).

Next, the carriage 50 is moved in the direction of the arrow A in the figure, and the distance control member 51 slides relative to the carriage 50 and the sliding member 58. When a second contact surface 51c of the distance control member 51 becomes coplanar with the supporting surface 58a provided in the sliding member 58, the carriage 50 is stopped. Thus, the distance control member 51 can be disposed at the second control position (see FIG. 12).

Similarly, by making a third contact surface 51d of the distance control member 51 coplanar with the supporting surface 58a provided in the sliding member 58, the distance control member 51 can be disposed at the third control position (see FIG. 13).

Similarly, by making a fourth contact surface 51e of the distance control member 51 coplanar with the supporting surface 58a provided in the sliding member 58, the distance control member 51 can be disposed at the fourth control position (see FIG. 14).

In each of the contact surfaces 51b, 51c, 51d, and 51e, the distance control member 51 varies in the thickness in the direction substantially perpendicular to the recording surface. Therefore, the paper distance can be controlled.

To return the distance control member 51 from any one of the above control positions to the original position, the distance control member 51 is slid in the reverse direction. Specifically, first, the switching member 59 is brought into contact with the other side surface of the protrusion 51a in the main scanning direction (the side surface on the side of the opposite direction from the arrow A in FIG. 11).

Next, the carriage 50 is moved in the opposite direction from the arrow A in FIG. 11, and the distance control member 51 slides relative to the carriage 50 and the sliding member 58. By controlling the position of the distance control member 51, the distance control member 51 can be disposed at any control position.

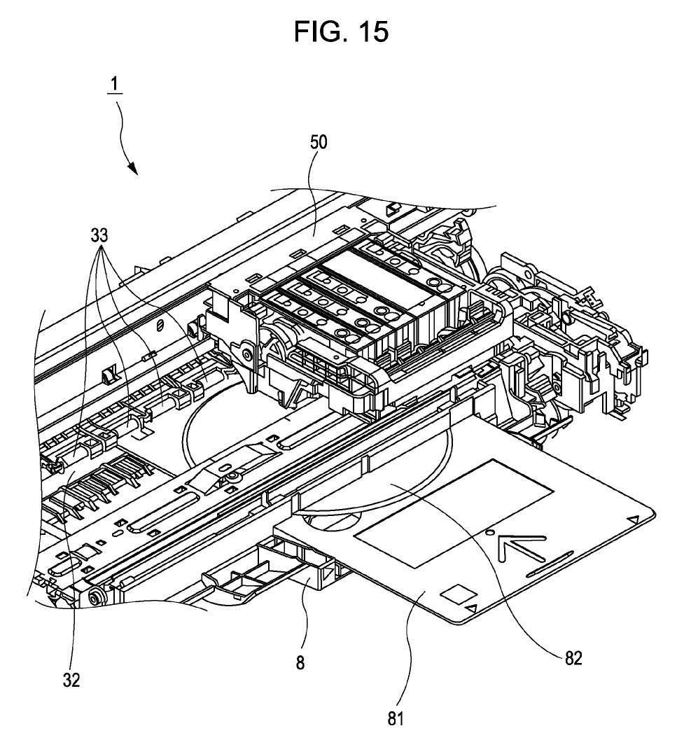

When printing is performed on a CD-R, it is desirable to use a CD-R conveying tray to convey the CD-R. FIG. 15 is a schematic perspective view of the recording apparatus 1 that is conveying a CD-R conveying tray 81.

The CD-R conveying tray 81 with a CD-R mounted thereon is supported by a CD-R tray base 8 and is conveyed through the feeding mechanism 2 to the conveying section 3. The CD-R conveying tray 81 can be formed, for example, of a plastic material about 3 mm thick.

The configurations of other parts of the carriage unit 5 will be described with reference to FIGS. 1 and 2. The carriage 50 is driven by a motor 54 attached to the chassis 11, via a timing belt 55. This timing belt 55 is stretched tightly by an idle pulley 56.

To detect the position of the carriage 50, the carriage unit 5 is provided with a code strip 57 that has a plurality of equally-spaced marks thereon and extends parallel to the timing belt 55. That is, the marks of the code strip 57 are formed at regular intervals along the direction in which the carriage 50 moves. Normally, the interval between the marks is 150 to 300 lpi (“lpi” is a unit of the number of screen lines).

The carriage 50 is provided with an encoder that reads the above marks. By reading the marks with the encoder, the position of the carriage can be detected. Thus, the carriage can perform scanning with a high degree of accuracy.

The recording apparatus 1 may be provided with a sensor that detects the thickness or type of a recording medium. In that case, according to the thickness or type of a recording medium, the distance control member 51 can be automatically controlled.

### (B) Feeding Mechanism

As shown in FIGS. 1 and 2, the feeding mechanism 2 has a pressing plate 21 on which recording media are loaded, a feeding roller 27 that feeds recording media, a separating roller 26 that separates recording media, and a return lever 22 for returning recording media to the loading position. These components are attached to a base 20.

In addition, a paper feeding tray (not shown) for holding the loaded recording medium is attached to the base 20 or a case (not shown).

The pressing plate 21 is configured to be able to brought into and out of contact with the feeding roller 27 by a pressing plate cam (not shown). The pressing plate 21 is rotatable around a rotating shaft joined to the base 20, and is urged by a pressing plate spring toward the feeding roller 27. The pressing plate 21 is provided with side guides 23, which are movable in the main scanning direction. The side guides 23 define the loading position where recording media are loaded.

The feeding roller 27 is cylindrical and rotatable in the recording medium conveying direction. The feeding roller 27 feeds recording media.

The base 20 is further provided with a separating roller holder. The separating roller 26 is rotatably attached to the separating roller holder. The separating roller holder is rotatable around a rotating shaft provided in the base 20.

The separating roller holder is urged by a separating roller spring (not shown) toward the feeding roller 27. Thus, the separating roller 26 is pressed against the feeding roller 27.

A clutch spring (not shown) is attached to the separating roller 26. When a load more than a predetermined value is applied, a part to which the separating roller 26 is attached can rotate. The separating roller 26 is configured to be able to brought into and out of contact with the feeding roller 27 by a separating roller release shaft (not shown) and a control cam (not shown).

The return lever 22 for returning recording media to the loading position is rotatably provided in the base 20 and is urged by a return lever spring (not shown) in the releasing direction. When recording media are returned to the loading position, the return lever 22 is rotated by the control cam.

At the start of a recording operation, first, the separating roller 26 and the feeding roller 27 come into contact with each other. Then, the recording media loaded on the pressing plate 21 are pressed against the feeding roller 27. Next, the feeding of the recording media is started.

At this time, the feeding of the recording media is limited by a front separating portion provided in the separating roller holder, and only a predetermined number of recording media are nipped between the separating roller 26 and the feeding roller 27. The predetermined number of recording media fed are separated by the separating roller 26. Thus, only the uppermost recording medium is fed to the conveying section 3.

When the recording medium reaches the conveying section 3, the pressing plate 21 is released by the pressing plate cam, and the separating roller 26 is released by the control cam. The return lever 22 is returned by the control cam to the loading position. At this time, the recording media other than the uppermost one nipped between the feeding roller 27 and the separating roller 26 are returned to the loading position.

In this way, only one recording medium is separated from a plurality of recording media loaded on the pressing plate 21 and is fed to the conveying section 3.

### (C) Conveying Section

As shown in FIGS. 1 and 2, the conveying section 3 has a conveying roller 32 that conveys a recording medium, an edge detector (not shown) that detects the edge of a recording medium, and a plurality of pinch rollers that are rotationally driven by the conveying roller 32. The pinch rollers 33 are held by a pinch roller holder 30 and are in contact with the conveying roller 32. A recording medium conveyed to the conveying section 3 is nipped between the conveying roller 32 and the pinch rollers 33 and is further conveyed toward the platen 34.

The platen 34 is provided on the downstream side of the conveying roller 32 in the conveying direction, and supports the recording medium at a position where the recording medium faces the recording head 7. The platen 34 has ribs formed thereon. The ribs form a conveying datum plane. These ribs control the distance to the recording head 7 and prevent the recording medium from waving, together with the ejecting section 4 to be described below.

The pinch rollers 33 are pressed against the conveying roller 32 by a pinch roller spring (not shown). Thus, force that conveys the recording medium is generated. The rotating shaft of the pinch roller holder 30 is attached to a bearing formed in the chassis 11.

The above-described edge detector is provided to detect the leading edge and the trailing edge of the recording medium. Thus, the conveyance of the recording medium can be detected.

On the downstream side of the conveying roller 32 in the recording medium conveying direction, the recording head 7 is provided that forms an image on the basis of image information. For example, an ink jet recording head is used as the recording head 7.

Liquid reservoirs 71 that store liquid to be ejected are detachably attached to the recording apparatus 1. Normally, in an ink jet recording apparatus, a liquid reservoir is attached for each color of ink (liquid to be ejected).

This recording head 7 can apply heat to liquid, for example, using heaters. This heat causes film boiling of liquid. The expansion or contraction of bubbles formed by film boiling causes pressure change, which ejects liquid through nozzles formed in the recording head 7. This liquid forms an image on the recording medium.

In the above configuration, the recording medium conveyed to the conveying section 3 is conveyed by the conveying roller 32 and the pinch rollers 33 to the platen 34. At this time, the leading edge of the recording medium is detected by the edge detector. Thus, the position on the recording medium where image recording is performed can be determined.

When an image is formed on the recording medium, the recording medium is conveyed, and the carriage is reciprocated in the main scanning direction. On the basis of an electric signal from an electric board provided in the recording apparatus 1, ink (liquid) is ejected from the recording head 7. Thus, ink is ejected onto the recording medium, and an image recording is performed.

### (D) Ejecting Section

As shown in FIGS. 1 and 2, the ejecting section 4 has an ejecting roller 40 and a spur 42. The spur 42 is pressed against the ejecting roller 40 at a predetermined pressure and is rotationally driven.

The ejecting roller 40 is attached to the platen 34. The metal shaft of the eject roller 40 is provided with a plurality of rubber portions. The ejecting roller 40 is driven by the driving force of the conveying roller 32 transmitted via a transmitting roller (not shown).

The spur 42 is formed, for example, by integrating a stainless steel sheet having a plurality of protrusions around it, with a resin portion. The spur 42 is attached to a spur holder.

In this embodiment, the spur 42 is attached to the spur holder using a spur spring that is a rod-like coil spring. By another spring, the spur 42 is pressed against the ejecting roller 40.

Due to the above configuration, the recording medium on which an image has been formed by the recording head 7 is ejected by the ejecting roller 40 and the spur 42, out of the recording apparatus 1.

### (E) Recovery Mechanism

The recovery mechanism 6 has a cap unit 61 for preventing the ejection surface of the recording head 7 from drying. The cap unit 61 is connected to a suction unit 60 serving as a negative pressure generator.

When the recording head 7 is not in operation, the cap unit 61 is in close contact with the ejection surface and covers the nozzles formed in the recording head 7. Thus, the ejection surface of the recording head 7 can be protected, and the ink in the nozzles can be prevented from drying.

To perform a recovery process using the cap unit 61, the carriage 50 is moved so that the ejection surface of the recording head 7 faces the cap unit 61. At this time, the preventing portion 52a prevents the sliding member 58 from moving in the direction substantially perpendicular to the recording surface (a prevented state).

By working the suction unit 60 in the capping state, ink can be sucked out of the nozzles. By sucking ink, thickened ink adhering to the inside and the surface of the nozzles, bubbles, and foreign substances can be removed.

The recovery mechanism 6 further has a wiping unit 62. The wiping unit 62 is a blade formed, for example, of an elastic body. The blade is configured to be able to move on the ejection surface of the recording head 7. Thus, the wiping unit 62 can wipe ink and dust off the ejection surface of the recording head 7.

Also when wiping is performed using a blade, the carriage unit 5 is desirably brought into a combined state and a prevented state.

While the present invention has been described with reference to embodiments in detail, it is to be understood that the invention is not limited to the embodiments. Various changes may be made without departing from the scope of the invention.

For example, in the above embodiments, a preventing portion 52a is provided so as to prevent the sliding member 58 from moving. However, the preventing portion 52a may be configured so as to prevent one of the carriage 50 and the distance control member 51 engaged with each other from moving in the direction substantially perpendicular to the recording surface.

The feeding mechanism 2, the conveying section 3, the ejecting section 4, and the recovery mechanism 6 may have any known configuration. The thickness and type of the recording medium are illustrative only, and various recording media can be used. The control of paper distance is not limited to four steps.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-156634 filed Jun. 16, 2008, which is hereby incorporated by reference herein in its entirety.

What is claimed is:

1. A recording apparatus comprising:
a carriage on which a recording head is mounted, the recording head ejecting liquid onto a recording medium;
a guiding member that guides the carriage that moves;
a sliding member that moves together with the carriage and that slides on the guide member;
a distance control member for controlling a distance between the recording head and the recording medium; and
a relative movement preventing unit that prevents the carriage from moving relative to the sliding member.

2. The recording apparatus according to claim 1, wherein the distance control member is configured to be slidable relative to the carriage, and the distance between the carriage and the sliding member is varied by sliding the distance control member.

3. The recording apparatus according to claim 1, wherein the distance control member is nipped between the carriage and the sliding member in the direction substantially perpendicular to the recording surface of the recording medium, the distance control member is configured to be slidable relative to the carriage, and the thickness of the distance control member in the direction substantially perpendicular to the recording surface differs depending on the position on the distance control member.

4. The recording apparatus according to claim 3, wherein the relative movement preventing unit includes units that combine the sliding member with the distance control member, and the units combine depending on the position of the distance control member relative to the carriage.

5. The recording apparatus according to claim 1, further comprising a preventing portion for preventing the carriage from moving in the direction substantially perpendicular to the recording surface when the relative movement preventing unit prevents the carriage from moving relative to the sliding member.

6. The recording apparatus according to claim 5, wherein the preventing portion prevents the carriage from moving when the carriage is located at a predetermined position.

7. The recording apparatus according to claim 6, wherein the preventing portion prevents the sliding member from moving in the direction substantially perpendicular to the recording surface.

8. The recording apparatus according to claim 2, further comprising a switching member for sliding the distance control member relative to the carriage.

9. The recording apparatus according to claim 8, wherein the switching member can move between a position where the switching member comes into contact with the distance control member when the carriage moves along the guiding member, and a position where the switching member does not come into contact with the distance control member when the carriage moves along the guiding member.

10. The recording apparatus according to claim 9, wherein moving the carriage with the switching member in contact with the distance control member slides the distance control member.

11. The recording apparatus according to claim 1, wherein the distance is controlled according to the type and thickness of the recording medium.
